(19) United States
(12) Patent Application Publication
(10) Pub. No.: US 2014/0067438 A1
(43) Pub. Date: Mar. 6, 2014

(54) POST-ACQUISITION CUSTOMIZATION OF BUNDLED PACKAGES FOR FULFILLMENT

(71) Applicant: David J. PESCH, La Palma, CA (US)

(72) Inventor: David J. PESCH, La Palma, CA (US)

(21) Appl. No.: 13/604,888

(22) Filed: Sep. 6, 2012

(51) Int. Cl. G06Q 30/00; G06Q 30/02; G06Q 50/10

(52) U.S. Cl. 705/5; 705/26.81; 705/14.11; 705/14.1

(57) ABSTRACT

The fulfillment of a predetermined package of one or more package items to a customer is disclosed. A unique fulfillment code corresponding to the predetermined package is received from the customer, as the package may have been previously acquired by the customer. Each package item has a defined monetary value range, and for each of the package items, one or more selectable options therefore in the defined monetary value range is retrieved. A form including each of the selectable options is transmitted to the customer, and a selection of one of the options is received thereafter. Each of the received selections is used for delivering a corresponding instrument representative thereof. The instrument is presentable to a vendor for settlement in exchange for provision of the selected option to the customer.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to online fulfillment services for bundled travel and event packages, and more particularly, to post-acquisition customization of bundled packages for fulfillment purposes.

2. Related Art

Non-profit organizations exist for a wide range of subjects, as well as issues of public welfare and the common good. There are groups for particular interests such as, for example, the arts, athletic activities, and personal hobbies, as well as those dedicated exclusively to charitable and philanthropic causes such as education, scientific and medical research, environmental and wildlife issues, civil rights, and so forth. Although some are funded from a single source such as corporations and foundations established by wealthy individuals, most depend heavily on membership and outside contributions to continue operating in its pursuit of chartered goals. As such, fundraising is a critical undertaking necessary to the very survival of most non-profit organizations.

Those charged with leading the fundraising efforts have developed a variety of events and activities to entice donors to contribute. Mail and telephone based drives solicit contributions at the individual level, but this is understood to be time-consuming and labor intensive. However, basically any social gathering can be turned into a charity event, and indeed, depending on the demographics of the invitees and the popularity or interest level in the cause, the social aspects of formal fundraising galas, other parties of smaller scale, golf tournaments, and various other social gatherings may be as enjoyable and interesting to the attendees as the philanthropic aspects. Such events serve the dual purpose of bringing awareness to the cause or issue for which they are being held, and the increased attendance is beneficial to that end. Furthermore, the increase in donations is a welcome benefit to the host organization, as the typical operating procedure is to donate portions of the admission price, and further in-person solicitations can be made during the event itself.

Aside from money collected from admissions and straight donations, charity events typically hold raffles for various prizes. Entry tickets are sold throughout the duration of the event, with a drawing for the winner being conducted at the end. The prizes are oftentimes items that are either donated or provided at cost from corporate underwriters and other major sponsors of the event, but with numerous individuals vying for the possibility of winning one or only a few prizes, much more money can be raised than from a single sale or transfer of the item. Commodity items can be given as door prizes, and gifts can be given for additional donations at tiered levels above that of the admission price. For example, donations at an X dollar amount may have one associated thank-you gift, donations at a Y dollar may have another thank-you gift with a commensurate difference in value, and so on.

Another popular event is the auction, where different items of value are donated to or purchased at cost by the hosting organization. Attendees can bid on those items, with the proceeds from the winning bid being donated to the organization. The reserve is typically set so that despite a minimal bid, the organization does not realize any losses in relation thereto. Any items for which no bids were placed or the reserve was not met, may be returned to the original donor, or kept for a future auction.

One item that is commonly offered to patrons through the aforementioned charity events, whether as a raffle prize, as a bid item, or as a thank-you gift, is the bundled travel or event package. For example, vacation and travel packages may include roundtrip airfare, other transportation, and accommodations, as well as certain meals and activities. Single event packages may include tickets to events such as concerts, plays, etc., along with drink or meal vouchers, transportation, accommodations, and perhaps related souvenir items. The package bundles may be configured in numerous different ways, though the particular selection of the items therein sets the cost and hence the perceived value to the donor who ultimately acquires it. The individual items in the package are typically acquired at fixed wholesale prices lower than are offered to retail consumers, with the understanding that any of the usual markups for similar items will constitute a donation. However, there are conditions attendant to such lower pricing, such as black-out dates, exclusions, validity periods and the like. The task of assembling these packages, including the selection of each item, and the negotiation of pricing and terms, is handled by third party businesses.

The packages are purchased or consigned by the non-profit organization, which then offers them to potential customers/patrons in the aforementioned ways. After the purchaser/patron chooses a package, the organization accepts payment and requests additional personal information as well as the dates and other specifics to the extent the package allows variations. In some instances, the travel dates and other details are already pre-selected, and the package is offered by the organization with the understanding that the winner would be able to make use of it. The organization then makes the arrangements with the individual vendors of each item, and forwards any confirmatory documentation to the patron. In other instances, the purchaser/patron is offered a voucher or certificate for a predetermined amount, leaving the task of booking with that voucher or certificate with the purchaser/patron.

Because most purchasers/patrons do not know their schedules beyond more than a few weeks or so in advance, they are unable to commit to a travel date immediately at the time of acquisition. This necessitates a periodic follow up from the organization, thereby increasing the administrative burden on staff. Compounding this is the difficulty associated with the planning and scheduling necessary for a trip of such magnitude, and as a result, acquired packages often go unused. As further time passes, interest may wane, and the desirability of traveling or attending the event may diminish to such a point that even a minimal level of effort to complete fulfillment is no longer worthwhile. Fulfillment is burdensome regardless of the rare circumstance where the purchaser/patron sets all the details quickly and without difficulty, because of the need for the non-profit organization, which likely does not count amongst its staff full-time travel agents accustomed to such work, to complete the necessary arrangements. Furthermore, under existing modalities, the business that assembles the packages has no knowledge of the purchaser/patron, although it is perhaps in the best position to handle fulfillment and other customer service functions.

Thus, in general, existing travel and event package bundling modalities are problematic for the purchaser/patron, the non-profit organization, and the business assembling the packages alike for different but related reasons. Accordingly, there is a need in the art for an improved fulfillment service for travel and event packages. There is also a need in the art for post-acquisition customization of bundled travel and event packages.

### BRIEF SUMMARY

The present disclosure contemplates an online fulfillment center that services various organizations and its patrons who purchase travel and event experiences as part of charitable fundraising efforts. Via the fulfillment center, patrons/customers can customize the different features of the travel and event package post-acquisition and prior to fulfillment.

In accordance with one embodiment of the present disclosure, a machine-executed method for fulfilling a predetermined package of one or more package items to a customer is envisioned. The method may begin with receiving from the customer a unique fulfillment code corresponding to the predetermined package. The predetermined package may be previously acquired by the customer, with each package item having a defined monetary value range. The method may continue with retrieving, for each of the package items of the predetermined package, one or more selectable options for the package items in the defined monetary value range. There is also a step of transmitting a form to the customer. The form may include each of the selectable options for each of the package items and a description of the predetermined package. The method may also include receiving, for each of the package items, a selection of one of the one or more selectable options as included in the transmitted form. Each of the received selections of the one of the one or more selectable options may be used for delivering a corresponding instrument representative thereof. The instrument may be presentable to a vendor for settlement in exchange for provision of the selected option for the corresponding one of the package items to the customer. This method may be tangibly embodied in an article of manufacture comprising a non-transitory program storage medium readable by a computer system.

According to another embodiment of the present disclosure, there is also a machine-executed method of processing a primary predetermined package of one or more package items previously acquired by a customer from a third party organization. The method may include a unique fulfillment code from the customer. The code may correspond to the primary predetermined package, and each package item thereof may have a defined monetary value range. Additionally, there may be a step of converting the defined monetary value range of each package item to a point value. Then, there may be a step of summing each of the point values of the package items in the primary predetermined package to generate a total package point value. Furthermore, the method may include adding the total package point value to a preexisting point balance associated with the customer. There may be a step of receiving a redemption selection from the customer. The redemption selection may be one of a merchandise exchange, a re-donation, and a package exchange.

From the perspective of the customer, the present disclosure includes a method for requesting fulfillment of a package of one or more selectable package items. The method may include purchasing the package from a third party organization. The package may be identified by a fulfillment code. There may also be a step of establishing a user account with a fulfillment website. A submitted user name and a mailing address may then be associated with the user account. The method continues with transmitting the fulfillment code to the fulfillment website. In response, the method may include receiving one or more selectable options for the package items in a customer form from the fulfillment website. The form may include a description of the predetermined package and details of the package items. Thereafter, the method may include entering a selection of the one or more selectable options for each of the package items in the customer form. The method may further include initiating the submission of the customer form to the fulfillment website. Again, each of the received selections of the one of the one or more selectable options may be used for delivering a corresponding instrument representative thereof. The instrument may be presentable to a vendor for settlement in exchange for provision of the selected option for the corresponding one of the package items to the customer.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating the various parties to a bundled event/travel package, including a patron/customer, a fulfillment center, a third-party organization, and vendors, and their inter-relationships;

FIG. 2 is a diagram illustrating the event/travel package and its items;

FIG. 3 is a flowchart illustrating a method for requesting fulfillment of the bundled event/travel package from the perspective of the patron/customer;

FIG. 4 is a flowchart illustrating one method for fulfillment of the bundled event/travel package in accordance with one embodiment of the present disclosure;

FIG. 5 is a flowchart illustrating another method for processing the bundled event/travel package in which the package is redeemed for either merchandise, for another package, or re-donated;

FIG. 6 is a screen capture of an online service implementing the method for fulfillment, and in particular, an initial login screen;

FIG. 7 is a screen capture of the online service showing an account enrollment screen;

FIG. 8 is a screen capture of the online service where a fulfillment code is being requested;

FIG. 9 is a screen capture of the online service showing a redemption page from which various fulfillment and redemption options can be selected;

FIG. 10 is a screen capture of the online service showing a form with selectable options for each of the package items and a description of the same;

FIG. 11 is a screen capture of the online service showing a merchandise exchange catalog; and

FIG. 12 is a screen capture of the online service showing a package exchange catalog.

Common reference numerals are used throughout the drawings and the detailed description to indicate the same elements.

### DETAILED DESCRIPTION

The present disclosure is directed to a fulfillment center for purchasers of travel and event experiences. The detailed description set forth below in connection with the appended drawings is intended as a description of certain embodiments of the methods for requesting fulfillment and fulfilling purchased packages, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second and the like are used solely to distinguish one entity from another without necessarily requiring or implying any actual such relationship or order between such entities.

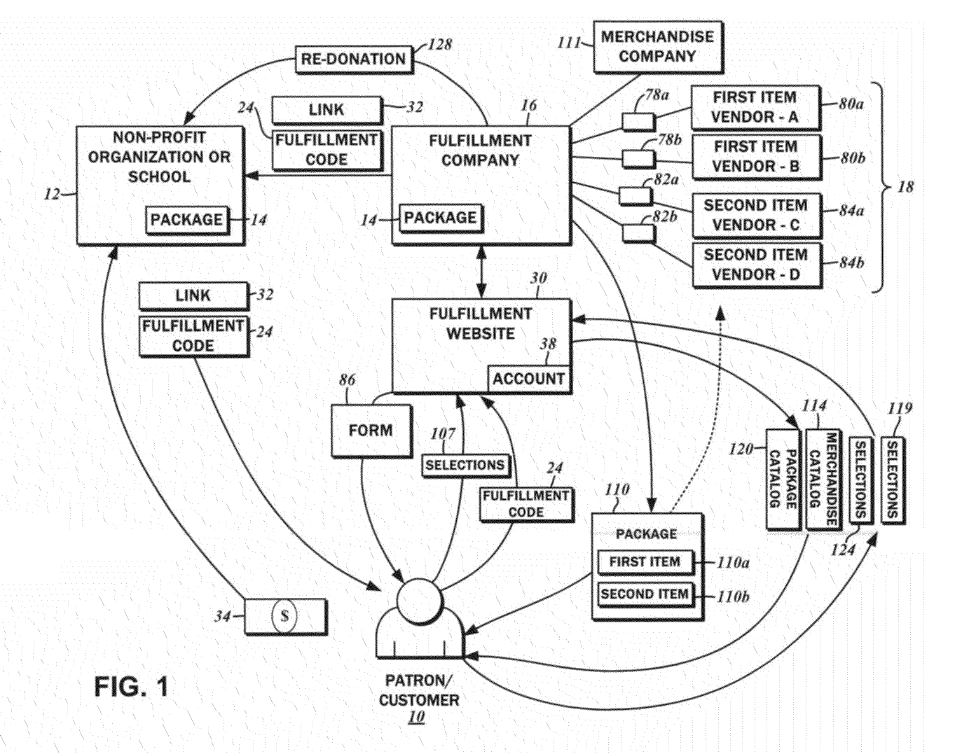

With reference to the block diagram of FIG. 1, the primary participants involved are a customer 10, an organization 12 offering a predetermined travel or event package 14 to the customer 10, and a fulfillment company 16. Additionally, there are various vendors 18 who provide services to the customer 10. The organization 12 is understood to be a non-profit or school that offers the package 14 for fundraising purposes. Depending on the specifics of the fundraising activity, the organization 12 expects to receive an amount of money exceeding the wholesale price paid for the package 14, and indeed, the fair market value as well. Any excess is intended to be given to the organization 12 for use in continuing its operations.

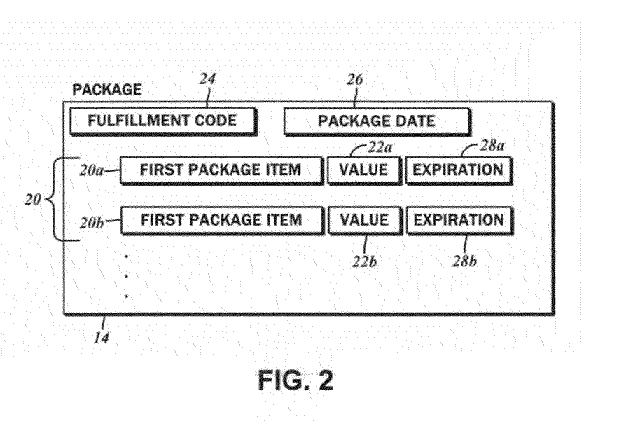

As best shown in the diagram of FIG. 2, the package 14 is a bundling of various services or products, generally referred to as package items 20. In the particular example illustrated, there is a first package item 20a and a second package item 20b. Each of the package items 20 have an associated cost value component 22, which is tied to the respective prices charged by the vendors 18 therefore. If, for example, the package 14 is a destination travel package, the first package item 20a may be airfare or other travel services, while the second package item 20b may be overnight accommodations. In another example, if the package 14 is an event package, the first package item 20a may be tickets to the event, and the second package item 20b may be a dining/snack voucher. There are limitless post-acquisition item 20 selection variations of the bundled package 14, as each package item 20 allows the customer to select from multiple competing products, vendors or providers of items that may include lodging, services, tours, events, games, tournaments, contests, concerts, shows, experiences, gift cards, vouchers, gift certificates, apparel, merchandise, restaurants, venues, advertisers, sponsors, all modes of transportation and transportation services, as well as selections that include cities, states, countries, dates, times, ages of participants and experience levels of participants. Those having ordinary skill in the art will recognize the selections of the package items 20 and groupings or arrangements that are likely to be of interest to a given target demographic.

The fulfillment company 16 arranges various packages 14 by negotiating favorable deals with the vendors 18, and may sell, donate, or otherwise provide the same to the organization 12 for fundraising purposes. Because in most cases the fulfillment company 16 only negotiates a finite number of package items 20, for each package 14 that is so provided to the organization 12, a unique identifier is assigned as a fulfillment code 24. Furthermore, to the extent the package 14 has a set date for use, it is so indicated by a package date 26. If there are expiration dates for any of the package items 20, those would be indicated by an item expiration date 28. In most cases, airfare and travel vouchers are valid for one year, though there may be variations to this duration.

The exemplary embodiments are described in terms of the organization “selling” the package 14, though the “customer” 10 can perhaps be more appropriately referred to as a donor or patron. As mentioned above, there a several ways for utilizing the package 14, and any other item for that matter, for fundraising purposes. One popular fundraising activity is the auction, where different bidders make bids or offers, and the highest offer is awarded with the auction item. In this circumstance, it may be appropriate to refer to the patron as the “customer” 10, and the package 14 being “sold” thereto. It is to be understood, however, that such terms as selling, sales, and purchases are utilized for purposes of convenience only and not of limitation. For example, another popular fundraising activity is the prize raffle, where nominal amounts of money are collected from numerous participants, with one being awarded with the item and the remaining proceeds being donated to the organization 12. In this case, the term “customer” may not precisely describe the winner, but it is expressly contemplated that the presently disclosed methods are just as applicable to these alternative acquisition scenarios.

The specific identities and categorical names applied to the various parties and the transactions between them as shown in FIG. 1 are by way of example, and any alternative embodiments may involve differently named parties and transactions. Thus, the customer 10 is understood to encompass anyone who acquires the package 14, and the non-profit organization 12 is understood to be any entity including non-profit organizations and schools that offer the package 14 in exchange for the collection of funds, whether as donations or otherwise.

An embodiment of the present disclosure envisions a fulfillment website 30 associated with and managed by the fulfillment company 16, and is understood to be the primary modality by which the packages 14 are redeemed. Therefore, when the fulfillment company 16 offers the package 14 to the organization 12, it also provides a link 32 that the final customer 10 can use to access the fulfillment website 30. In further detail, the fulfillment website 30 is understood to be a conventional server computer system with connectivity to the Internet, and running a web/HTTP (HyperText Transfer Protocol) server that accepts requests for data and transmits the requested data in response.

The aforementioned fulfillment code 24 for the particular package 14 is also provided to the organization 12 so that the customer 10 can specify the one that was acquired. The fulfillment code 24 and the link 32 are the minimal items that are provided to the organization 12 by the fulfillment company 16. Other information and materials such as enticing descriptions and pictures of the package 14 and its constituent package items 20 may also be provided.

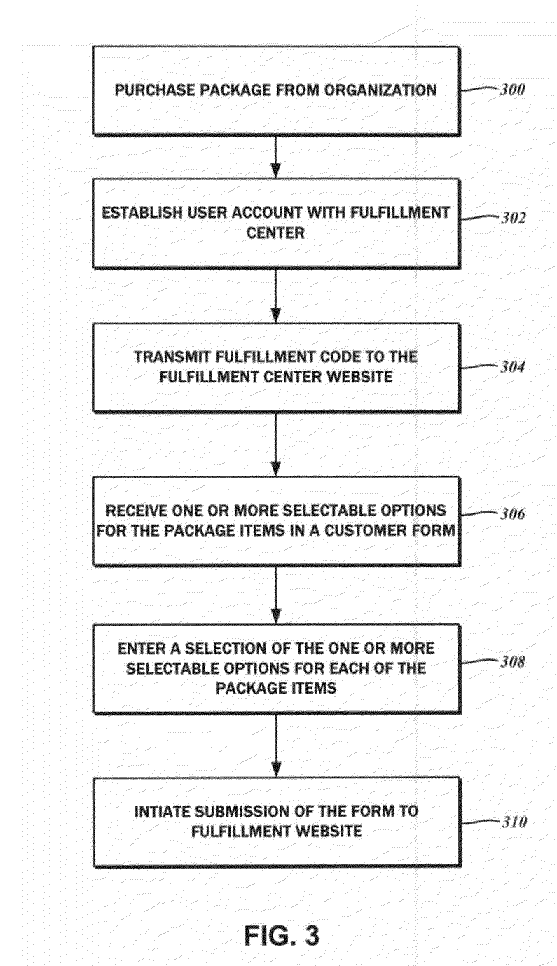

Within the foregoing context of the fulfillment company 16 and its fulfillment website 30, the organization 12, and the customer 10, there are various methods for requesting fulfillment of the package 14 and for fulfilling the package 14. The flowchart of FIG. 3 illustrates one contemplated method for requesting fulfillment, which begins with a step 300 of the customer 10 purchasing the package from the organization 12. Again, the term purchase is understood to encompass any activity that results in the customer 10 acquiring ownership of the package 14, and may involve the customer 10 rendering a payment 34 to the organization 12. The payment 34 may be described as a pledge, donation, a contribution, a bid, or any other suitable term as dictated by the circumstances under which the organization 12 is offering the package 14 to the customer 10. As indicated above, the organization 12 may provide the fulfillment code 24 and the link 32 to the customer 10 in exchange for the payment 34.

As an alternative to the organization 12 providing the fulfillment code 24 and the link 32, it may instead solicit the e-mail address of the customer 10. Optionally, additional identifying information may also be requested, such as the name, mailing address, and telephone number of the customer 10. This information may be passed to the fulfillment company 16, which then e-mails the link 32 and the fulfillment code 24 to the customer 10.

Having been provided with the fulfillment code 24 and the link 32, when the customer 10 is ready to commit to fulfillment, he or she may access the fulfillment website 30 using the link 32 thereto. Those having ordinary skill in the art will recognize that the customer 10 can utilize a computer including a web browser application. Over the Internet or any other suitable data communications modality, such computer/web browser application transmits a request to the fulfillment website 30 for data, and renders the results.

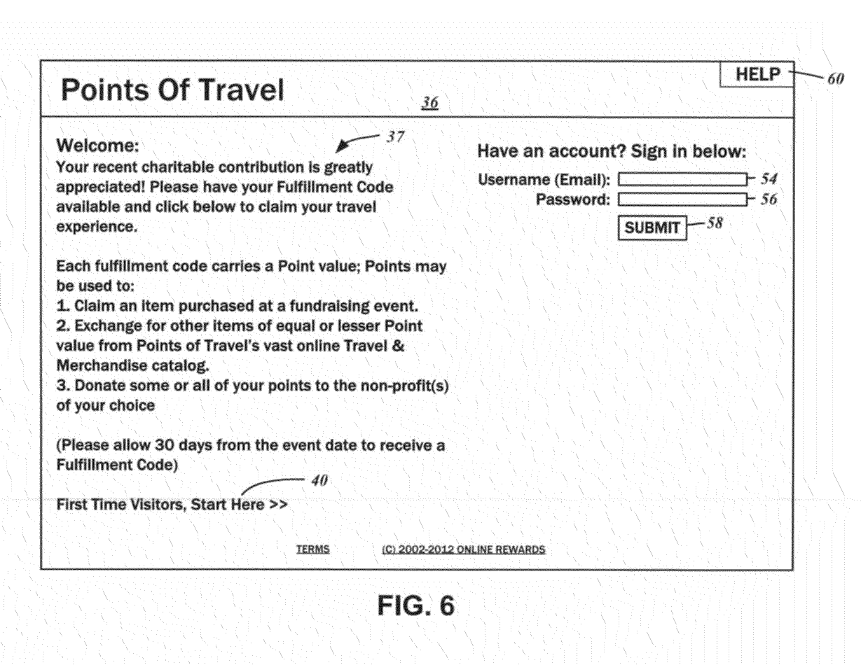

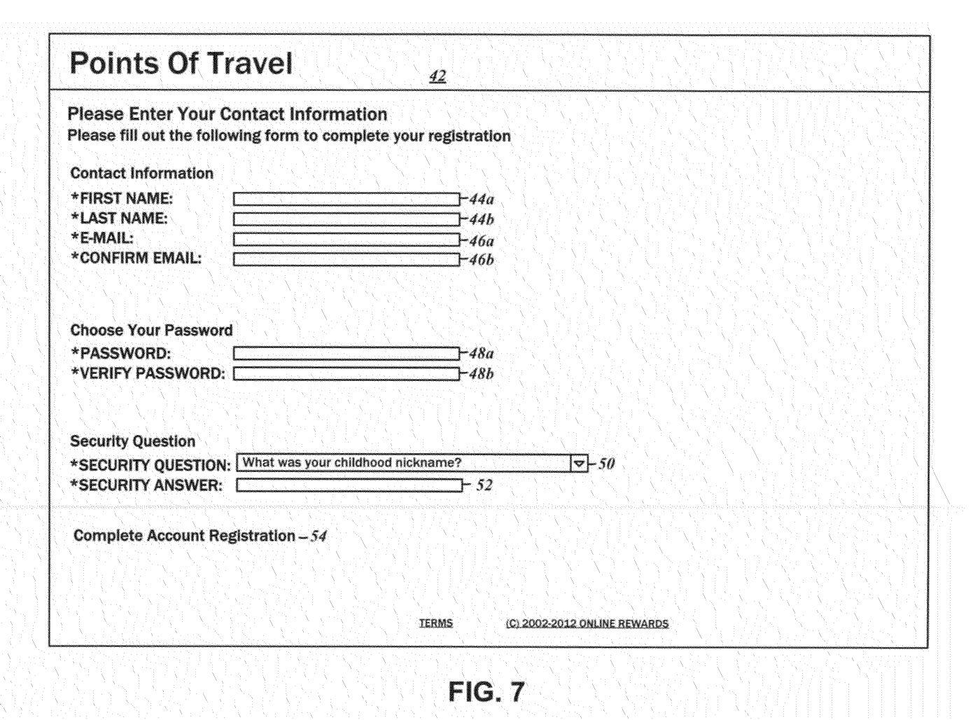

As best illustrated in the screen capture of FIG. 6, the online service, i.e., the fulfillment website 30 generates and transmits an initial login screen 36 upon access. A basic textual description 37 of the fulfillment website 30 may be provided. However, access to and use thereof is generally limited to those with a user account 38 that is protected with a password. In this regard, first-time visitors are requested to select a link 40 to an account establishment page 42, the details of which are shown in the screen capture of FIG. 7. Selecting the link 40 to the account establishment page 42 also initiates a step 302 of establishing the user account 38 with the fulfillment website 30. The account establishment page 42 includes first name input field 44a and last name input field 44b. Furthermore, there is an e-mail address input field 46a and an email address confirmation input field 46b. A desired password is set and confirmed with password input and confirmation fields 48a, 48b, respectively. As a measure against losing the password and safeguarding against unauthorized password recovery attempts, there is a security question pull-down list 50, and a security question answer field 52 in which the customer's 10 answer to the selected security question may be entered. The foregoing is presented as one exemplary implementation of the account establishment page 42, and additional information such as mailing addresses, telephone numbers, and the like can also be requested. Following input of the data requested in the account establishment page 42, a submission link 54 may be selected to proceed and save the account 38.

For those customers 10 providing identifying information to the organization 12 without receiving the fulfillment code 24 and the link 32, it may be possible for the fulfillment company 16 to pre-establish the account 38 on behalf of the customer 10 prior to the initial access using the information provided to the organization 12. When this occurs, it is understood that the aforementioned step 302 of establishing the user account is performed by the fulfillment company 16. Referring back to the initial login screen 36 of FIG. 6, the e-mail address may be entered into an e-mail input field 54. If the password has already been delivered to the customer 10, then it may be entered into a password input field 56, followed by activating a submit button 58. On the other hand, if a password is not yet assigned but the account is, a link 60 to a conventional password recovery modality may be selected, whereupon supplying an answer to a security question, either a new password may be generated and sent to the stored e-mail address, or the existing password may be sent to the stored e-mail address.

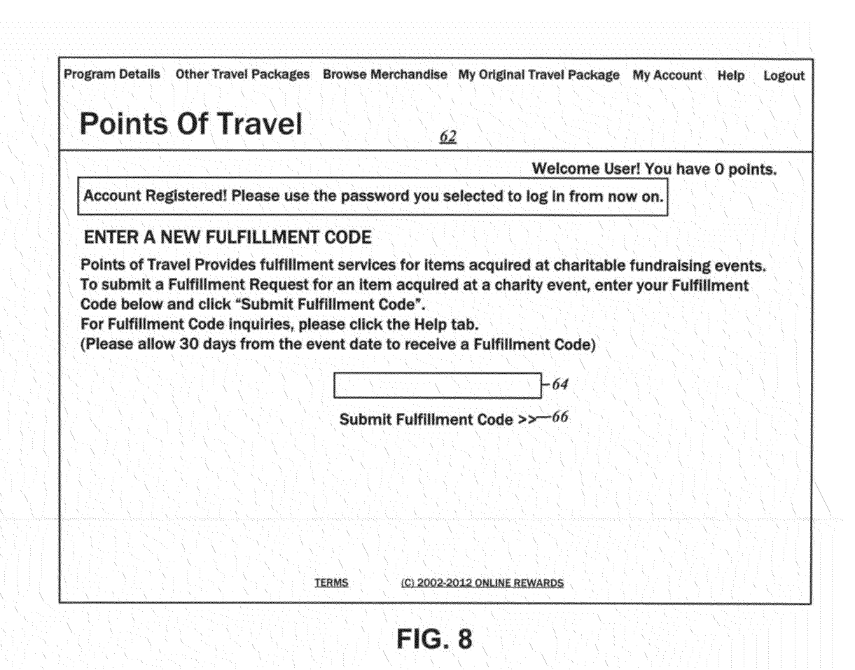

After logging in to the account 38, the method for requesting fulfillment may continue with a step 304 of transmitting the fulfillment code 24 to the fulfillment website 30. As shown in FIG. 8, the customer 10 may provide this in a fulfillment code entry page 62, and specifically, in a code input field 64. Once entered, activating a submit button 66 is operative to transmit the entered fulfillment code 24 for further processing.

As briefly indicated above, various embodiments of the present disclosure also contemplate methods for fulfilling the package 14, as performed by the fulfillment company 16. The methods may be machine-executable and run on the aforementioned server of the fulfillment website 30. The step 304 of transmitting the fulfillment code 24 has a corollary step 400 of receiving the fulfillment code 24 for the package 14 from the customer 10. There is also a method envisioned for, generally, redeeming the package 14 for merchandise, re-donating the total value of the package 14 back to the organization 12, or exchanging for a different package 14, and this method likewise contemplated a corollary step 500 of receiving the fulfillment code 24.

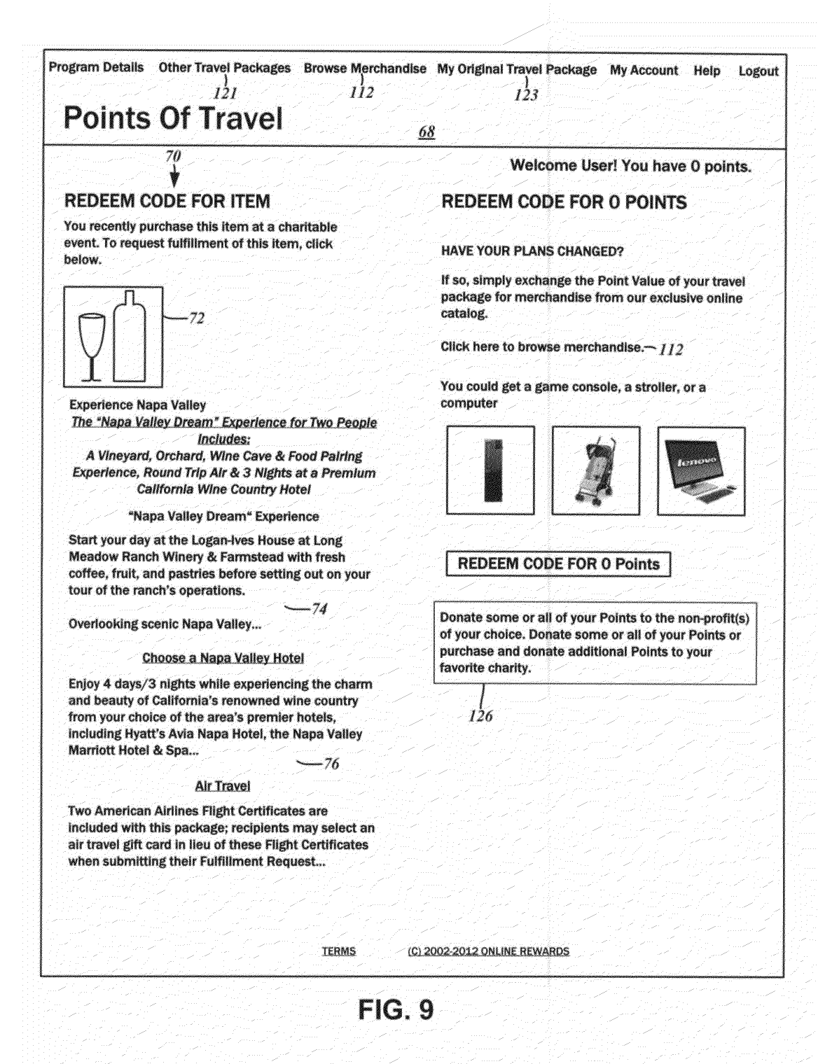

Following receipt of the fulfillment code 24, the method for fulfillment continues with a step 402 of retrieving one or more selectable options for each of the package items 20 in the package 14. Referring to the screen capture of FIG. 9, there may be an intermediary step presenting a package descriptor page 68, which is laid out with a primary column 70 including a picture 72 representative of the package 14. The example package 14 is a “Napa Valley Dream” wine country experience that includes winery visits, round-trip airfare, and overnight accommodations. An overview description 74 thereof is included in the package descriptor page 68. Further, additional details 76 are included for each of the selectable options. The form and contents of the package descriptor page 68 is presented by way of example only, and may be varied according to the desired aesthetics of the fulfillment website 30.

Continuing with the previously presented example, and referring to the diagrams of FIGS. 1 and 2, each package item 20 may have multiple vendors 18, and for the first package item 20a, there may be a first item selectable option 78a provided by a first item vendor 80a, and another first item selectable option 78b provided by a different first item vendor 80b. With the first package item 20a being, for example, airfare, the first item selectable option 78a may be vouchers from American Airlines, while the other first item selectable option 78b may be vouchers from United Airlines. For the second package item 20b, by way of example, there may be one second item selectable option 82a provided by a second item vendor 84a, and another second item selectable option 82b provided by a different second item vendor 84b. If the second package item 20b is overnight accommodations, the one second item selectable option 82a may be hotel vouchers for the Marriott chain hotel. Another second item selectable option 82b may be hotel vouchers for a Hyatt chain hotel. It will be understood that there may be any number of vendors and any number of selectable options, even multiple ones from the same vendor. Along these lines, there may be more than the two noted package items 20a, 20b in the package 14. Generally, the cost value component 22 of each of the options is understood to be at similar levels, though it is possible to offer upgraded options with the payment of additional fees by the customer 10. Upgrades may also be offered free of charge for customers 10 who are existing members of a loyalty program of the vendor 18.

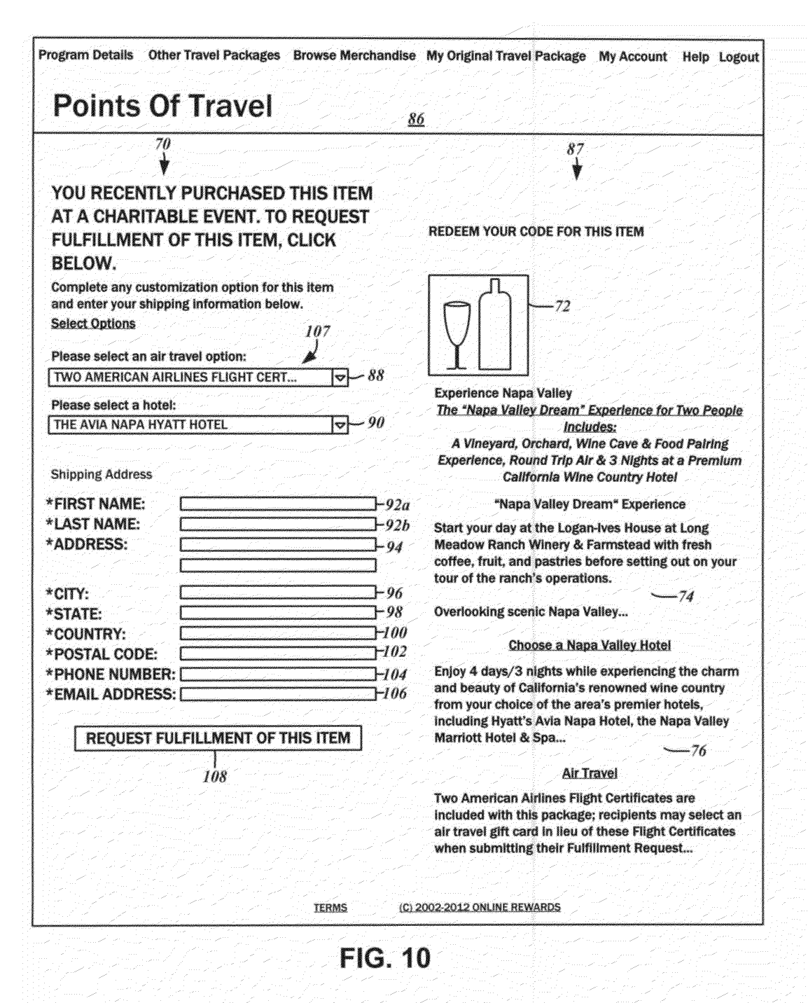

Following retrieval of the various selectable options 78, 82 for the package items 20a, 20b, respectively, the method for fulfillment continues with a step 404 of transmitting to the customer 10 a customer form 86 that includes the selectable options 78, 82. One exemplary embodiment of the customer form 86 is shown in FIG. 10, which also includes the aforementioned picture 72, the overview description 74, and the additional details 76. These may be presented in a second column 87 instead of the first column 70 as with the package descriptor page 68. The first column 70 now includes a first pull-down menu 88 that corresponds to the first package item 20a, e.g., the airfare options. The first pull-down menu 88 includes a list item for the first item selectable option 78a, e.g., the voucher for American Airlines, and another list item for the other first item selectable option 78b, e.g., the voucher for United Airlines. Similarly, there is a second pull-down menu 90 that corresponds to the second package item 20b, e.g., the overnight accommodations options. The list items of the second pull-down menu 90 correspond to one of the second item selectable option 82a, e.g., vouchers for the Marriott chain, and the other second item selectable option 82b, e.g., vouchers for the Hyatt chain. Where upgrade options are also possible, these are also understood to be listed in the respective pull-down menus 88, 90.

Optionally, though preferably, the customer form 86 requests mailing information, as it is not necessary for the account 38 to retain it. In further detail, there is a name input fields 92, i.e., a first name input field 92a and a last name input field 92b. Furthermore, there is an address input field 94, a city input field 96, a state input field 98, a country input field 100, a postal code input field 102, a phone number input field 104, and an e-mail input field 106. To the extent some of this information can be retrieved from the account 38, such as the first and last name and e-mail address as having been previously stored, those input fields can be pre-populated.

Referring also to the flowchart of FIG. 3, the step 404 of transmitting form 86 to the customer 10 involves a corollary step 306 of receiving the form 86 with the one or more selectable options 78a-b, 82a-b in the method for requesting fulfillment. Following receipt of the form 86, the customer 10 can make selections 107 of one of the options for each package item 20 in a step 308, e.g., either the American Airlines voucher or the United Airlines voucher, and either the Marriott hotel voucher or the Hyatt hotel voucher. These selections 107 are to be submitted to the fulfillment website 30 to complete the fulfillment process, at least to the extent necessary to substantially conclude the involvement of the customer 10. To this end, according to a step 310, the method for requesting fulfillment contemplated initiating the submission of the form 86 and hence the selections 107 by activating a submit button 108.

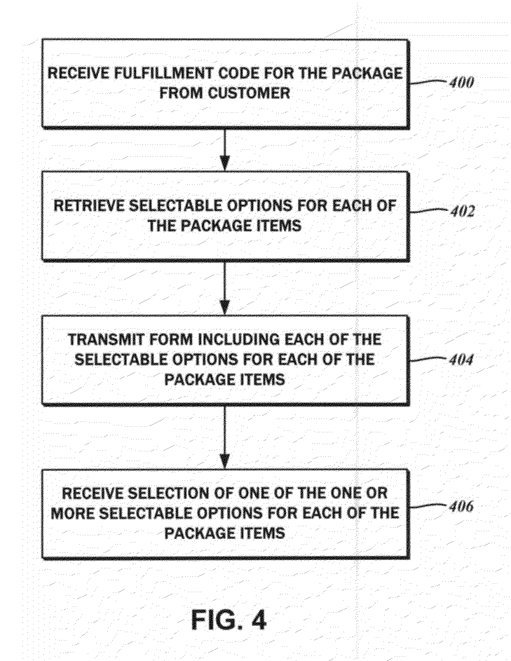

In turn, referring primarily to the flowchart of FIG. 4, the above-described step 310 has a corollary step 406 in the method of fulfillment of receiving the selections 107 of one of the one or more selectable options 78a-b, 82a-b as set in the form 86. With the selections 107 recorded by the fulfillment website 30, the fulfillment company 16 delivers corresponding instruments 110 making up the package 14. More particularly, there is a first instrument 110a for the selected one of the options of the first package item 20a, and a second instrument 110b for the selected one of the options of the second package item 20b. The instruments 110 are delivered to the customer 10 as specified in the submitted address, and understood to be presentable to the respective vendors 18 in exchange for their selected services.

With reference again to the package descriptor page 68 of FIG. 9, various embodiments of the present disclosure contemplate the alternative disposition of the package 14. As mentioned above, it is possible to redeem the package 14 for merchandise, re-donate the value of the package 14 to the organization 12, or exchange for a different package 14. Following the submission of the fulfillment code 24 in the step 500, the method may continue with a step 502 of converting the monetary range values 22 of each package item 20 to a point value. The value of each point may be set arbitrarily, and can fluctuate depending on changing wholesale pricing considerations. Each of the point values may be summed to yield a total package point value in a step 504. The customer 10 may have already purchased other packages 14 and has similarly redeemed them in the manner discussed herein, and so the total package point values thereof may be added to the account 38. Upon summing the total package point value for the package 14 currently being processed, it is added to the existing tally in the account 38 per a step 506. The preexisting point balance may be zero if the customer 10 was not involved in any other transactions. Nevertheless, the summed total package point value of the package 14 is saved to the account 38.

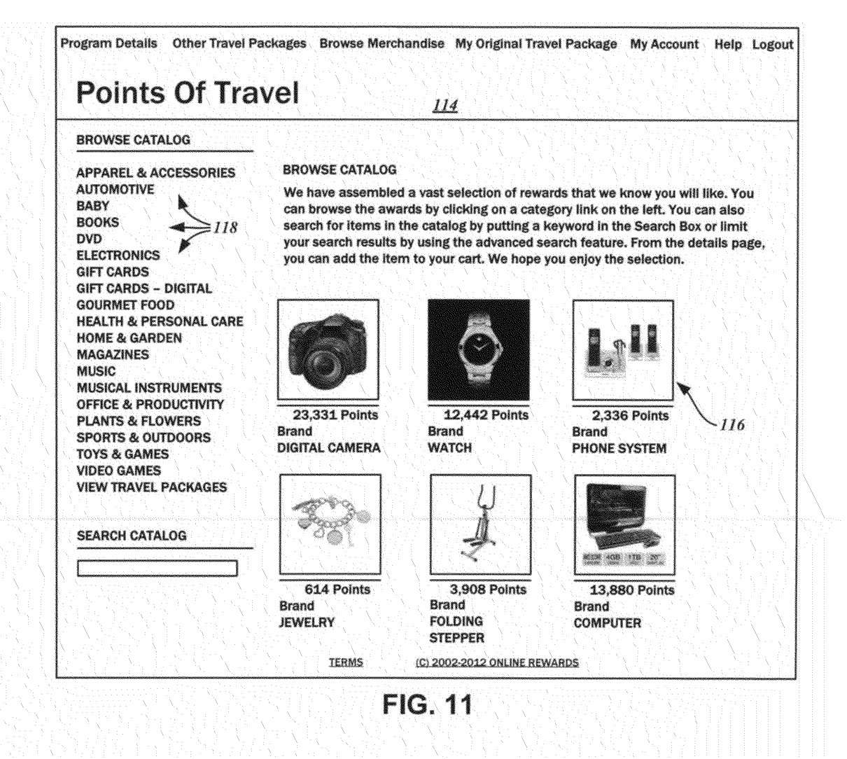

A selection of one of the disposition options of merchandise redemption, package exchange, and re-donation is received from the customer 10 in accordance with a step 508. Returning to the package descriptor page 68 shown in FIG. 9, the customer 10 may alternatively select a merchandise redemption link 112 to use the point balance associated with the account for other items besides that originally specified in the package 14. In accordance with a step 510, and with additional reference to the screen capture of FIG. 11, the method may continue with transmitting a merchandise catalog 114 of merchandise items 116 that is redeemable for the points. Under each listing of the merchandise item 116, there is an item picture, item title, a brief description, and the point cost to purchase it. The merchandise catalog 114 may be grouped and segregated into various categories for easier viewing, and can be accessed from individual catalog sections 118. Those having ordinary skill in the art will recognize the various ways in which the merchandise catalog 114 may be presented to the customer, and any such variation can be substituted without departing from the scope of the present disclosure. As shown in the package descriptor page 68, certain excerpts of the merchandise catalog 114 may be displayed therein.

Upon a merchandise item 116 being selected by the customer 10, such selection 119 is received by the fulfillment website 30 in accordance with a step 512. The purchase is completed if the point value of the item 116 is less than or equal to the point balance recorded in the account 38 Like the fulfillment of the individual package items 20, the item 116 is delivered to the customer 10 at a specified mailing address. An inventory of each of the merchandise items 116 in the merchandise catalog 114 can be maintained by the fulfillment company 16, but a more efficient and cost-effective alternative is to outsource such operations to a merchandise company 111.

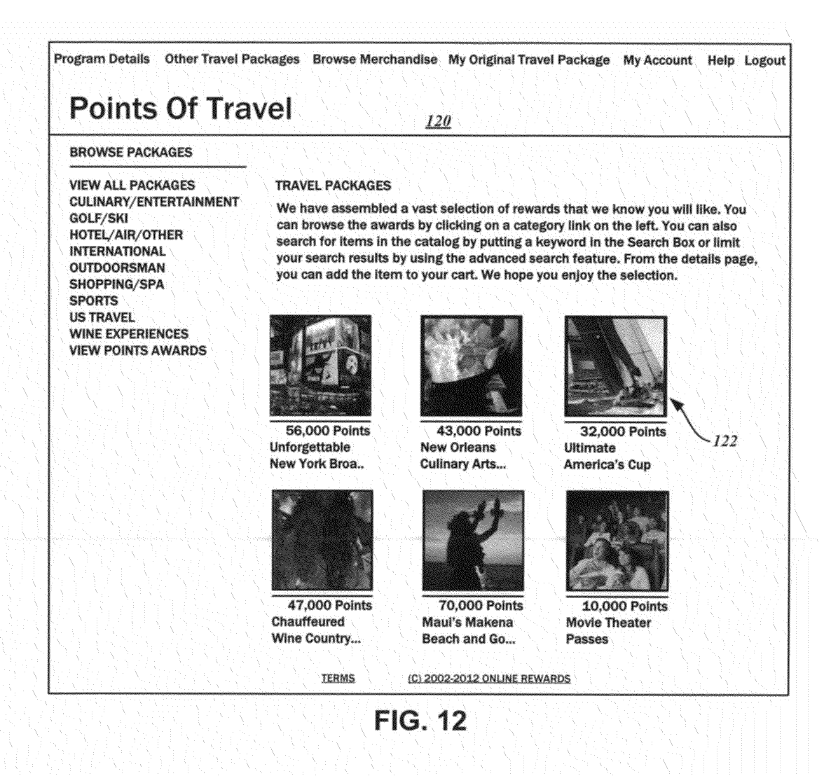

A similar procedure takes place when the customer 10 desires to exchange the package 14 for an alternative. This feature can be invoked by selecting a package exchange link 121. With additional reference to the screen capture of FIG. 12, the method includes a step 520 of transmitting a package catalog 120 including listings of different, secondary packages 122 that can be selected, provided that the account 38 has a sufficient balance for exchange. The point values of the secondary packages 122 may be predetermined in accordance with the values of the individual package items thereof. A desired secondary package 122 is selected by the customer 10, and the selection 124 is received by the fulfillment website 30 per step 522. Thereafter, in accordance with the modalities discussed above, the secondary package 122 is delivered to the customer 10, that is, the instruments 110 are mailed or otherwise provided to the customer 10. If at any time the originally purchased package 14 is desired, an original package link 123 can be selected, which is operative to retrieve the package descriptor page 68.

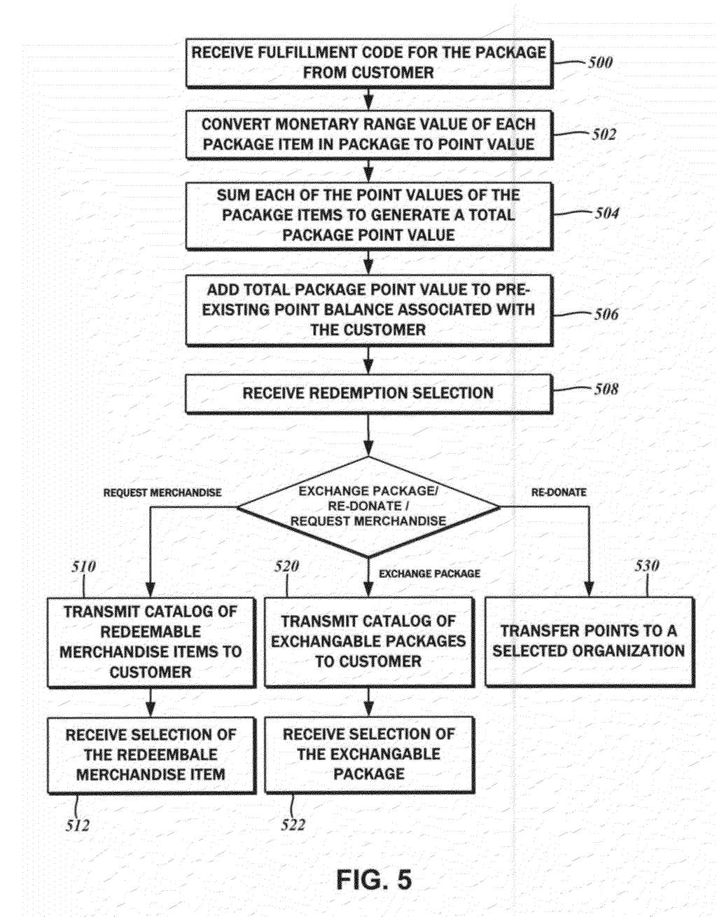

A third alternative contemplates the re-donation of the whole point value or a partial point value of the package 14 back to a non-profit organization or school 12 of the customer's choice. Referring back to the package descriptor page 68 of FIG. 9 and the flowchart of FIG. 5, the method continues with a step 530 of transferring the points in an amount equal to or less than the total package point value back to the organization 12. There may be an intermediate confirmation step that may involve presenting a user interface element that is then activated by the customer 10.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details of the present disclosure with more particularity than is necessary, the description taken with the drawings making apparent to those skilled in the art how the several forms of the present disclosure may be embodied in practice.

What is claimed is:

1. A machine-executed method for fulfilling to a customer a predetermined package of one or more package items, the method comprising:
receiving from the customer a unique fulfillment code corresponding to the predetermined package, the predetermined package being previously acquired by the customer, with each package item having a defined monetary value range;
retrieving, for each of the package items of the predetermined package, one or more selectable options for the package items in the defined monetary value range;
transmitting to the customer a form with each of the selectable options for each of the package items and a description of the predetermined package; and
receiving, for each of the package items, a selection of one of the one or more selectable options as included in the transmitted form;
wherein each of the received selections of the one of the one or more selectable options is used for delivering a corresponding instrument representative thereof, the instrument being presentable to a vendor for settlement in exchange for provision of the selected option for the corresponding one of the package items to the customer.

2. The method of claim 1, wherein the form includes fields requesting input of customer delivery data, the receiving of the selection of the one of the one or more selectable options being accompanied by inputs of the customer delivery data.

3. The method of claim 1, wherein the predetermined package is a destination travel package.

4. The method of claim 3, wherein one of the package items is air travel.

5. The method of claim 3, wherein one of the package items is an overnight accommodation.

6. The method of claim 1, wherein the predetermined package is for an event, and one of the package items is an admission ticket to the event.

7. The method of claim 1, wherein a loyalty program identifier is linked with the customer, the loyalty program identifier being associated one of the vendors of the selectable options of the corresponding one of the package items.

8. The method of claim 7, wherein an upgraded selectable option for the corresponding one of the package items is retrieved, and transmitted to the customer in the form, the selected one of the one or more selectable options is the upgraded selectable option.

9. The method of claim 1, wherein the option items have a validity duration.

10. A machine-executed method of processing a primary predetermined package of one or more package items previously acquired by a customer from a third party organization, the method comprising:
receiving from the customer a unique fulfillment code corresponding to the primary predetermined package, each package item thereof having a defined monetary value range;
converting the defined monetary value range of each package item to a point value;
summing each of the point values of the package items in the primary predetermined package to generate a total package point value;
adding the total package point value to a preexisting point balance associated with the customer; and
receiving a redemption selection from the customer, the redemption selection being one of a merchandise exchange, a re-donation, and a package exchange.

11. The method of claim 10, wherein if the redemption selection is the merchandise exchange, the method further includes:
transmitting to the customer a first catalogue of redeemable merchandise items, each redeemable merchandise having a corresponding item point value; and
receiving a selection of the redeemable merchandise item in which the corresponding item point value is less than or equal to the preexisting point balance associated with the customer;
wherein the selected redeemable merchandise item is delivered to the customer.

12. The method of claim 10, wherein if the redemption selection is the re-donation, the method further includes:
transferring points in an amount less than or equal to the total package point value to an account of the third party organization.

13. The method of claim 10, wherein if the redemption selection is the package exchange, the method further includes:
transmitting to the customer a second catalogue of secondary predetermined packages of one or more secondary package items, each secondary package item thereof having a defined monetary value range;
receiving a selection of one of the secondary predetermined packages listed in the second catalogue, a sum of the defined monetary value ranges of each secondary package item thereof being less than or equal to the preexisting point balance of the customer;
retrieving, for each of the secondary package items of the selected one of the secondary predetermined packages, one or more secondary selectable options for the secondary package items in the defined monetary value range;
transmitting to the customer a form with each of the secondary selectable options for each of the secondary package items and a description of the selected one of the secondary predetermined packages; and
receiving, for each of the secondary package items, a selection of one of the one or more secondary selectable options as included in the transmitted form;
wherein each of the received selections of the one of the one or more secondary selectable options is used for delivering a corresponding instrument representative thereof, the instrument being presentable to a vendor for settlement in exchange for provision of the secondary package item to the customer.

14. The method of claim 10, wherein the predetermined package is a destination travel package.

15. The method of claim 14, wherein one of the secondary package items is air travel.

16. The method of claim 14, wherein one of the secondary package items is an overnight accommodation.

17. The method of claim 10, wherein the predetermined package is for an event, and one of the secondary package items is an admission ticket to the event.

18. The method of claim 10, wherein the secondary package items have a validity duration.

19. A method for requesting fulfillment of a package of one or more selectable package items, comprising:
purchasing the package from a third party organization, the package being identified by a fulfillment code;
establishing a user account with a fulfillment web site, a submitted user name and a mailing address being associated with the user account;
transmitting the fulfillment code to the fulfillment website;
receiving from the fulfillment website in response to transmitting the fulfillment code, one or more selectable options for the package items in a form, the form including a description of the predetermined package and details of the package items;
entering a selection of the one or more selectable options for each of the package items in the form; and
initiating the submission of the form to the fulfillment website;
wherein each of the received selections of the one of the one or more selectable options is used for delivering a corresponding instrument representative thereof, the instrument being presentable to a vendor for settlement in exchange for provision of the selected option for the corresponding one of the package items to the customer.

20. The method of claim 19, wherein the predetermined package is a destination travel package.

21. The method of claim 20, wherein one of the package items is air travel.

22. The method of claim 20, wherein one of the package items is an overnight accommodation.

23. The method of claim 19, wherein the predetermined package is for an event, and one of the package items is an admission ticket to the event.

24. An article of manufacture comprising a non-transitory program storage medium readable by a computer system, the medium tangibly embodying one or more programs of instructions executable by the computer system to perform a method for fulfilling to a customer a predetermined package of one or more package items, the method comprising:
receiving from the customer a unique fulfillment code corresponding to the predetermined package, the predetermined package being previously acquired by the customer, with each package item having a defined monetary value range;
retrieving, for each of the package items of the predetermined package, one or more selectable options for the package items in the defined monetary value range;
transmitting to the customer a form with each of the selectable options for each of the package items and a description of the predetermined package; and
receiving, for each of the package items, a selection of one of the one or more selectable options as included in the transmitted form;
wherein each of the received selections of the one of the one or more selectable options is used for delivering a corresponding instrument representative thereof, the instrument being presentable to a vendor for settlement in exchange for provision of the selected option for the corresponding one of the package items to the customer.
